(19) United States
(12) Patent Application Publication
(10) Pub. No.: US 2016/0068404 A1
(43) Pub. Date: Mar. 10, 2016

(54) PROCESS FOR HEAT RECOVERY FROM AMMONIA STRIPPER IN ANDRUSSOW PROCESS

(71) Applicant: INVISTA NORTH AMERICA S.A R.L., Wilmington, DE (US)

(72) Inventors: John C. CATON, Yoakum, TX (US); David W. RABENALDT, Port Lavaca, TX (US)

(73) Assignee: INVISTA NORTH AMERICA S.A R.L., Wilmington, DE (US)

(21) Appl. No.: 14/741,797

(22) PCT Filed: Dec. 12, 2013
(86) PCT No.: PCT/US13/74640

§ 371 Date: Jun. 17, 2015

Related U.S. Application Data
(60) Provisional application No. 61/738,662, filed on Dec. 18, 2012.

(51) Int. Cl. C01C 3/02; B01D 53/14

(52) U.S. Cl. CPC C01C 3/0295; B01D 53/1418; B01D 53/1425; B01D 53/1406; B01D 2252/103

(57) ABSTRACT

A hydrogen cyanide production process that recovers ammonia and hydrogen cyanide from a crude hydrogen cyanide product comprising from 25 to 50 vol. % water. When heat is recovered from the ammonia stripper, in the form of low pressure steam, and the steam can be integrated with the refining of hydrogen cyanide.

### CROSS REFERENCE TO RELATED APPLICATION

This application claims priority to U.S. App. No. 61/738,662, filed Dec. 18, 2012, the entire contents and disclosures of which are incorporated herein.

### FIELD OF THE INVENTION

The present invention relates to a process for producing hydrogen cyanide and more particularly, to an HCN production system for integrating heat recovered by an ammonia recovery system with a HCN refining system.

### BACKGROUND OF THE INVENTION

Conventionally, hydrogen cyanide (“HCN”) is produced on an industrial scale according to either the Andrussow process or the BMA process. (See e.g., Ullman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. Nos. 1,934,838 and 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane (See e.g., Ullman's Encyclopedia of Industrial Chemistry, Volume A8, Weinheim 1987, pages 161-163). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

U.S. Pat. No. 2,590,146 describes producing hydrogen cyanide by reacting methane, ammonia, and air in the presence of a platinum-iridium catalyst. Hydrogen cyanide is recovered from a gas comprising 23 vol. % water vapor by contacting the gas with an aqueous solution of an acidic boric acid-polyhydroxy organic complex to dissolve and vaporize off the hydrogen cyanide.

U.S. Pat. No. 3,718,731 describes a process for recovering ammonia from a mixture of gases comprising hydrogen cyanide. The ammonia is recovered in a stripper and two streams, each having a temperature of 40 to 70° C., are returned to the absorbing zone.

U.S. Pat. No. 4,530,826 describes a high temperature product gas leaving the HCN reactor which had been subjected to an effective utilization of heat in the waste heat boiler to lower the temperature, after which it was introduced into the ammonia-absorption column. The ammonia absorption column was maintained at a considerably high temperature to prevent the dissolution of hydrogen cyanide in the circulating aqueous sulfuric acid solution which flowed down in the column, so that the temperature of the circulating aqueous sulfuric acid solution was elevated to not less than 60° C. An absorption type refrigerator was placed at a position close to the hole for discharging the aqueous sulfuric acid solution from the bottom of the ammonia-absorption column and a refrigerant was produced therewith by using the aqueous sulfuric acid solution, whose temperature had been elevated as a driving source.

U.S. Pat. No. 7,785,399 describes systems and processes that utilize one or more methods of providing overhead waste process heat to increase the feed temperature of the hot solvent stripping regeneration loop in an acid gas removal process. Such processes are suited for the selective removal of hydrogen sulfide, carbonyl sulfide (COS) and other sulfur compounds, bulk removal of carbon dioxide, mercaptans, ammonia, hydrogen cyanide (HCN) and metal carbonyls.

Thus, what is needed is improved efficiency in recovering ammonia and refining hydrogen cyanide.

### SUMMARY OF THE INVENTION

One embodiment of the present invention is directed to a process for purifying a crude hydrogen cyanide product comprising hydrogen cyanide, ammonia, and from 25 to 50 vol. % water, the process comprising the steps of: contacting in an ammonia absorber at least a portion of the crude hydrogen cyanide product with an absorbing solution to produce an ammonia-rich stream containing ammonia and water and an ammonia absorber overhead stream containing hydrogen cyanide. In one aspect, the absorbing solution may be a lean phosphate solution which produces an ammonia-rich phosphate stream. The process further comprises separating in an ammonia stripper at least a portion of the ammonia-rich stream to vaporize ammonia and water into an ammonia stripper overhead and a lean stream; passing the ammonia stripper overhead through a waste heat boiler to generate steam having pressure of less than 400 kPa and to partially condense the ammonia stripper overhead into a liquid stream; passing at least a portion of the absorber overhead stream into a scrubber to remove residual ammonia to produce an ammonia scrubber off-gas stream; absorbing at least a portion of the off-gas stream in dilute acidified water to produce a hydrogen cyanide absorber off-gas stream and an absorber tails stream containing hydrogen cyanide; separating in a hydrogen cyanide stripper at least a portion of the hydrogen cyanide absorber tails stream to obtain an intermediate stream, wherein the steam from the waste heat boiler is directed to a calandria of the hydrogen cyanide stripper; and recovering in an enricher column a purified hydrogen cyanide product from the intermediate stream. The ammonia stripper overhead may comprise from 5 to 20 vol. % ammonia. The steam may be fed to a heat exchanger in a lower section of hydrogen cyanide stripper and wherein the steam provides from 40% to 60% of the energy to drive separation in the hydrogen cyanide stripper. The intermediate stream may be condensed into a liquid stream that is refluxed to the hydrogen cyanide stripper and a vapor distillate stream that is introduced into the enricher column, wherein the vapor distillate stream contains the heat needed to drive separation in the enricher column. The process may further comprise passing one or more recirculated dilute acid streams into the scrubber. The process may further comprise separating a tail stream from the scrubber and feeding the tail stream to the ammonia absorber. The crude hydrogen cyanide product may be formed from a ternary gas mixture that comprises at least 25 vol. % oxygen. The process may further comprise reducing the hydrogen cyanide concentration of the ammonia-rich stream prior to the ammonia stripper. The process may further comprise recovering ammonia from the partially condensed ammonia stripper overhead. The hydrogen cyanide enricher column may be operated to concentrate nitriles in the lower portion thereof. The process may further comprise cooling the lean stream by pre-heating the ammonia-rich stream in a process-to-process heat exchanger. The process may further comprise withdrawing a HCN stripper tails stream from the hydrogen cyanide stripper and cooling the HCN stripper tails stream by pre-heating the hydrogen cyanide absorber tails stream in a process-to-process heat exchanger. The off-gas stream may be partially condensed into a liquid stream and a vapor stream that are fed at different locations to the hydrogen cyanide absorber. The process may further comprise introducing an acid inhibitor into the hydrogen cyanide enricher. The absorbing solution may be a lean phosphate solution.

In a second embodiment, there is provided a process for purifying a crude hydrogen cyanide product comprising hydrogen cyanide, ammonia, and water, the process comprising the steps of: recovering ammonia from the crude hydrogen cyanide product using at least one lean phosphate solution and generating steam having pressure of less than 400 kPa by condensing an ammonia-water vapor stream; recovering hydrogen cyanide using acidified water from at least a portion of the crude hydrogen cyanide product and directing the generated steam to drive the separation of hydrogen cyanide and acidified water.

In a third embodiment of the present invention, there is provided a heat integration apparatus, comprising: an ammonia absorber for contacting a crude hydrogen cyanide product comprising hydrogen cyanide, ammonia, and water with an absorbing solution to produce an ammonia-rich stream containing ammonia and water, and an absorber overhead stream containing hydrogen cyanide; an ammonia stripper for separating at least a portion of the ammonia-rich stream to vaporize ammonia and water into an ammonia stripper overhead and a lean stream; a waste heat boiler for generating steam by passing the ammonia stripper overhead therethrough, wherein the steam has a pressure of less than 400 kPa, and for partially condensing the ammonia stripper overhead into a liquid stream; a scrubber for removing residual ammonia from at least a portion of the ammonia absorber overhead stream to produce an ammonia scrubber off-gas stream; an absorber for contacting a portion of the off-gas stream with dilute acidified water to produce a hydrogen cyanide absorber off-gas stream and a hydrogen cyanide absorber tails stream containing hydrogen cyanide; a hydrogen cyanide stripper for separating at least a portion of the hydrogen cyanide absorber tails stream to obtain a hydrogen cyanide stream, wherein the hydrogen cyanide stripper has a calandria; and a pipe for directing the steam from the waste heat boiler to the calandria. The pipe may have a length of less than 50 meters, preferably less than 25 meters. The apparatus may further comprise a reactor for producing the crude hydrogen cyanide product by contacting a ternary gas mixture with a catalyst. The catalyst may comprise platinum and rhodium. The apparatus may further comprise a condenser in the hydrogen cyanide stripper overhead for partially condensing the hydrogen cyanide stream into a liquid reflux stream and a vapor stream. The apparatus may further comprise a hydrogen cyanide enricher for purifying the vapor stream to obtain a hydrogen cyanide product. The apparatus may further comprise a process-to-process heat exchanger for transferring heat from the lean stream to the ammonia-rich stream. The absorbing solution may comprise an aqueous solution of mono-ammonium hydrogen phosphate and di-ammonium hydrogen phosphate. The apparatus may further comprise a partial condenser for condensing the off-gas stream into a liquid stream and a vapor stream that are fed at different locations to the hydrogen cyanide absorber. The apparatus may further comprise an ammonia enricher for distilling the partially condensed stripper overhead to recover ammonia.

### BRIEF DESCRIPTION OF THE DRAWINGS

FIG. 1 is a simplified schematic flow diagram of an HCN production system according to an embodiment of the presently claimed invention.

FIG. 2 is schematic flow diagram of an ammonia recovery system having heat integration with an HCN refining system according to an embodiment of the presently claimed invention.

### DETAILED DESCRIPTION OF THE INVENTION

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of,” or “selected from the group of consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment(s) described herein was/were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

Hydrogen cyanide (“HCN”) is produced on an industrial scale according to either the Andrussow process or by the BMA process. In the Andrussow process, methane, ammonia and oxygen-containing raw materials are reacted at temperatures above 1000° C. in the presence of a catalyst to produce a crude hydrogen cyanide product comprising HCN, hydrogen, carbon monoxide, carbon dioxide, nitrogen, residual ammonia, residual methane, and water. The catalyst is typically a wire mesh platinum/rhodium alloy or a wire mesh platinum/iridium alloy. Other catalyst compositions can be used and include, but are not limited to, a platinum group metal, platinum group metal alloy, supported platinum group metal or supported platinum group metal alloy. Other catalyst configurations can also be used and include, but are not limited to, porous structures, wire gauze, tablets, pellets, monoliths, foams, impregnated coatings, and wash coatings. In the BMA process, methane and ammonia are reacted using a platinum catalyst as described in U.S. Pat. No. 7,429,370 and incorporated by reference herein.

As would be understood by one of ordinary skill in the art, the source of the methane may vary and may be obtained from renewable sources such as landfills, farms, biogas from fermentation, or from fossil fuels such as natural gas, oil accompanying gases, coal gas, and gas hydrates as further described in VN Parmon, “Source of Methane for Sustainable Development”, pages 273-284, and in Derouane, eds. Sustainable Strategies for the Upgrading of Natural Gas: Fundamentals, Challenges, and Opportunities (2003). In some embodiments, the methane-containing source may comprise 90 vol. % methane and may be subjected to purification to recover purified methane.

HCN is typically produced by using air as the oxygen source in the Andrussow process. In order to improve system efficiency and to reduce capital and energy expenses, it may be preferably to use oxygen-enriched air or pure oxygen, as described herein. However, when oxygen-enriched air or pure oxygen is used, there are numerous concerns that arise both in the reaction and separation processes. In particular, using oxygen-enriched air or pure oxygen changes the crude hydrogen cyanide product composition. Table 1 shows exemplary compositions, in vol. %, of the crude hydrogen cyanide product when the ternary gas mixture comprises at least 25 vol. % oxygen.

TABLE 1
CRUDE HCN REACTOR PRODUCT
FROM OZYGEN ANDRUSSOW PROCESS

| Composition | Range (vol. %) | Range (vol. %) |
|---|---|---|
| HCN | 10 to 40 | 12 to 20 |
| NH₃ | 3 to 25 | 5 to 15 |
| CH₄ | 0.1 to 10 | 0.5 to 3 |
| CO₂ | 0.1 to 10 | 0.5 to 3 |
| H₂ | 10 to 60 | 20 to 50 |
| N₂ | 0.5 to 10 | 1 to 5 |
| CO | 0.1 to 10 | 1 to 5 |
| Ar | 0.01 to 1 | 0.05 to 0.5 |
| H₂O | 25 to 50 | 30 to 40 |
| Other nitriles | <1 | <0.1 |

In addition to Table 1, oxygen concentration of the crude hydrogen cyanide product is low, preferably less than 0.5 vol. %, and as higher amounts may trigger shut down events or necessitate purging. As shown in Table 1, when the oxygen Andrussow process is used, HCN concentration is increased, with a concomitant increase in water concentration and an increased concentration of unreacted ammonia, i.e. residual ammonia. The residual ammonia is separated from the crude hydrogen cyanide product and recovered. However, the increased water concentration in the crude hydrogen cyanide product changes the ammonia separation and recovery process. Unlike separating a crude hydrogen cyanide product produced by an air process, the water from the crude hydrogen cyanide product concentrates with the ammonia and not the hydrogen cyanide. In an air process, the water from the crude product concentrates with hydrogen cyanide and thus there is relativity less water in the ammonia separation process. Using the crude hydrogen cyanide product of the present invention, water needs to be removed from the ammonia. With the increased water concentration, higher temperatures are needed in the ammonia separation process and thus there is increased corrosion potential in the ammonia separation equipment. Surprisingly and unexpectedly, it has been found that when an oxygen-enriched air or a pure oxygen Andrussow process is used, the overhead stream from an ammonia stripper has an increased temperature that may be used to produce stream by passing the stream through a waste heat boiler. This passing of the stream through a waste heat boiler both decreases corrosion and allows for the recovered heat from the stream to be integrated with the HCN refining section of the process. In particular, the present invention can recover low pressure steam, e.g., steam having a pressure of less than 400 kPa, e.g. less than 315 kPa. Unless otherwise indicated as gauge, all pressures are absolute. In some embodiments, the steam has a pressure from 180 kPa to 400 kPa, e.g., from 180 to 380 kPa, from 180 to 310 kPa, or from 200 kPa to 280 kPa. It is understood that the low pressure steam has a pressure above atmospheric pressure but below 400 kPa. The low pressure steam, while generally less preferred, is suitable for use in the heat integration process where the ammonia stripper and HCN refining are closely located. The length of the pipe, which may be less than 50 m or less than 25 m, needed to transport the low pressure steam of the present invention is suitable for a closely located ammonia stripper and HCN refining.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, approximately 21 vol. % oxygen, approximately 1 vol. % argon, and approximately 0.04 vol. % carbon dioxide, as well as small amounts of other gases.

The term “oxygen-enriched air” as used herein refers to a mixture of gases with a composition comprising more oxygen than is present in air. Oxygen-enriched air has a composition including greater than 21 vol. % oxygen, less than 78 vol. % nitrogen, less than 1 vol. % argon and less than 0.04 vol. % carbon dioxide. Oxygen-enriched air may comprise greater than 21 to 100 vol. % oxygen, e.g., from greater than 21 to 99.5 vol. % oxygen, from greater than 21 to 95 vol. % oxygen, or from greater than 21 to 80 vol. % oxygen.

The formation of HCN in the Andrussow process is often represented by the following generalized reaction:

2CH₄+2NH₃+3O₂→2HCN+6H₂O

However, it is understood that the above reaction represents a simplification of a much more complicated kinetic sequence where a portion of the hydrocarbon is first oxidized to produce the thermal energy necessary to support the endothermic synthesis of HCN from the remaining hydrocarbon and ammonia.

Three basic side reactions also occur during the synthesis of HCN:

CH₄+H₂O→CO+3H₂

2CH₄+3O₂→2CO+4H₂O

4NH₃+3O₂→2N₂+6H₂O

In addition to the amount of nitrogen generated in the side reactions, additional nitrogen may be present in the crude product, depending on the source of oxygen. Although the prior art has suggested that oxygen-enriched air or pure oxygen can be used as the source of oxygen, the advantages of using oxygen-enriched air or pure oxygen have not been fully explored. When using air as the source of oxygen, the crude hydrogen cyanide product comprises the components of air, e.g., 78 vol. % nitrogen, and the nitrogen produced in the ammonia and oxygen side reaction.

Due to the large amount of nitrogen in air, it is advantageous to use oxygen-enriched air (which contains less nitrogen than air), in the synthesis of HCN because the use of air as the source of oxygen in the production of HCN results in the synthesis being performed in the presence of a larger volume of inert gas (nitrogen) necessitating the use of larger equipment in the synthesis step and resulting in a lower concentration of HCN in the product gas. Additionally, because of the presence of the inert nitrogen, more methane is required to be combusted (when air is used, as compared to oxygen-enriched air) in order to raise the temperature of the ternary gas mixture components to a temperature at which HCN synthesis can be sustained. Therefore, the use of oxygen-enriched air or pure oxygen instead of air in the production of HCN provides several benefits, including an increase in the conversion of natural gas to HCN and a concomitant reduction in the size of process equipment. Thus, the use of oxygen-enriched air or pure oxygen reduces the size of the reactor and at least one component of the downstream gas handling equipment through the reduction of inert compounds entering the synthesis process. The use of oxygen-enriched air or pure oxygen also reduces the energy consumption required to heat the oxygen-containing feed gas to reaction temperature.

It has been found that both productivity and production efficiency of HCN can be significantly improved, while maintaining stable operation, in part, by providing an oxygen-containing gas sufficiently enriched in oxygen and by adjusting the molar ratio of ammonia-to-methane to a sufficiently high level. In one embodiment, the ternary gas mixture has a molar ratio of ammonia-to-oxygen from 1.2 to 1.6, a molar ratio of ammonia-to-methane from 1 to 1.5, e.g., from 1.1 to 1.45, and a molar ratio of methane-to-oxygen from 1 to 1.25, e.g., from 1.05 to 1.15. For example, a ternary gas mixture may have a molar ratio of ammonia-to-oxygen of 1.3 and methane-to-oxygen 1.2. In another exemplary embodiment, the ternary gas mixture may have a molar ratio of ammonia-to-oxygen of 1.5 and methane-to-oxygen of 1.15. The oxygen concentration in the ternary gas mixture may vary depending on these molar ratios. It is understood that the molar ratios are temperature and pressure compensated. Further, the ternary gas mixture comprises at least 25 vol. % oxygen, e.g., at least 28 vol. % oxygen. In some embodiments, the ternary gas mixture comprises from 25 to 32 vol. % oxygen, e.g., from 26 to 30 vol. % oxygen.

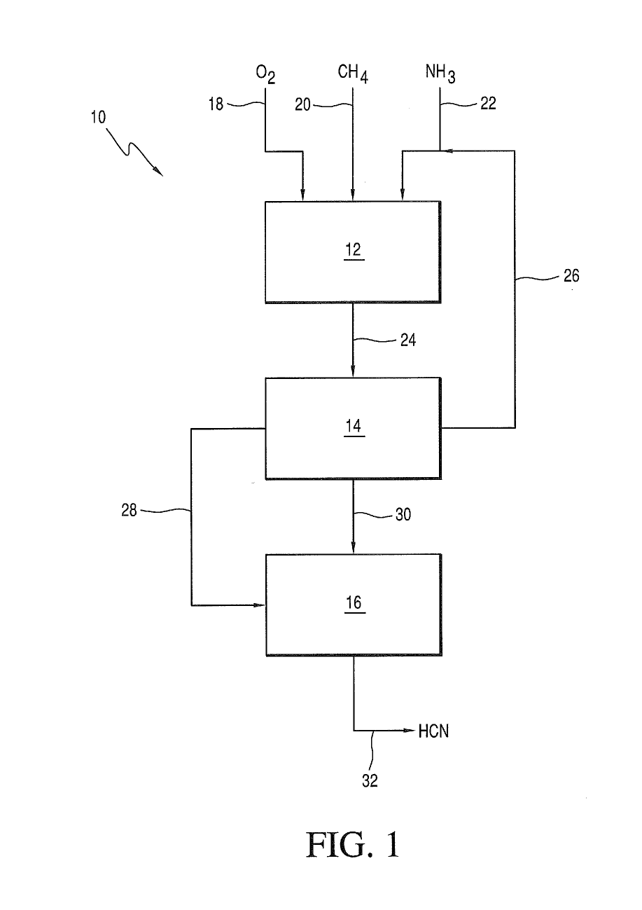

In general, FIG. 1 shows a HCN production system 10. Generally, the HCN is produced in a reaction assembly 12, ammonia recovery system 14 and HCN refining system 16. The reactant gases include an oxygen-containing feed stream 18, a methane-containing feed stream 20, and an ammonia-containing feed stream 22 are introduced into reaction assembly 12. In one aspect, the methane-containing gas may be obtained from a source that contains less than 90% methane and may be purified as needed. Reaction assembly may have a mixer comprising one or more static mixers for producing a thoroughly mixed ternary gas mixture that is passed over a catalyst bed.

A crude hydrogen cyanide product 24 is withdrawn from reaction assembly 12 and introduced into ammonia recovery system 14. Preferably, oxygen-enriched air or pure oxygen is used as a reactant gas to form crude hydrogen cyanide product 24. Due to oxygen concentrations of at least 25 vol. % in the ternary gas mixture, a higher water concentration is produced in crude hydrogen cyanide product 24. In one embodiment, crude hydrogen cyanide product 24 may comprise at least 25 vol. % water, e.g., at least 30 vol. % water. In terms of ranges, crude hydrogen cyanide product 24 may comprise from 25 to 50 vol. % water, e.g., 30 to 40 vol. % water. In contrast, when air is used as the reactant gas to form crude hydrogen cyanide product 24, water is present in an amount less than 25 vol. %, e.g., from 20 to 24 vol. %. Due to the higher water concentration in the off-gas produced in the oxygen-enriched air or pure oxygen process, ammonia recovery system 14 is run at higher temperatures to recover the ammonia that is recycled to reactor assembly 12 via line 26. Without being bound by theory, it is believed that the corrosive effects of ammonia on process equipment increase as temperature increases. To prevent corrosion in ammonia recovery system 14, the heated streams may be cooled by capturing the excess heat. Some of the heat used in ammonia recovery system 14 may be recovered using a waste heat boiler and directed as steam via line 28 to HCN refining system 16. For purposes of the present invention, the steam recovered is a low pressure steam having a pressure of less than 400 kPa, e.g., a pressure from 180 kPa to 380 kPa, from 180 kPa to 310 kPa, or from 200 kPa to 280 kPa. Due to the low pressure of the steam and the expense and infrastructure of transporting low pressure steam, the steam is closely integrated with the HCN refining system 16.

Advantageously, the heat recovered from the ammonia recovery system may be used to refine the HCN refining feed stream 30 into the purified HCN product 32. HCN refining is operated at certain temperatures to avoid fouling and plugging of equipment in the HCN refining system 16 caused by nitriles and polymerization. Maintaining a suitable temperature in HCN refining reduces or prevents autocatalytic HCN polymerization. Further, the increased heat needed to remove water in the ammonia stripper column may be efficiently captured and reused in numerous locations through the HCN purification system, thus improving the economics in producing HCN.

Waste heat boilers are typically used in reaction assembly 12 to rapidly quench the product gases to avoid decomposition of the HCN. The reaction is conducted at temperatures from 1000 to 1200° C., and the product gases need to be rapidly quenched to less than 600° C., e.g., less than 400° C. or less than 300° C. The present invention uses another waste heat boiler to recover heat inform the ammonia recovery system 14. The recovered heat, preferably in the form of low pressure steam, may be integrated with HCN refining system 16 to reduce the energy cost of producing the HCN product 32.

For purposes of the present invention, the waste heat boiler may be used to partially condense a stream from ammonia recovery system 14 that contains ammonia. However, desirable thermal integration may be obtained wherein the steam in line 28 is sourced from ammonia recovery system 14 at a pressure of less than 400 kPa, e.g., from 180 kPa to 380 kPa, from 180 kPa to 310 kPa, or from 200 kPa to 280 kPa. The steam pressure can be let-down to lower pressure as needed for consumption in HCN refining system 16. In one embodiment, the steam recovered from ammonia recovery system 14 may supply from 40 to 60% of the energy to drive separation of the HCN refining system 16, and in particular, to drive the hydrogen cyanide stripper.

The reactant gases are supplied to a reaction assembly, and more particularly to a mixing vessel, to provide a ternary gas mixture having at least 25 vol. % oxygen. The ternary gas mixtures it thoroughly mixed, and a thoroughly mixed ternary gas for the purposes of the present invention has a coefficient of variation (CoV) that is less than 0.1 across the diameter of the catalyst bed, or more preferably less than 0.05 and even more preferably of less than 0.01. In terms of ranges, the CoV may be from 0.001 to 0.1, or more preferably from 0.001 to 0.05. Low CoV beneficially increases the productivity of reactants being converted to HCN. CoV is defined as the ratio of the standard deviation, a, to the mean, μ. Ideally, CoV would be a low as possible, for example less than 0.1, for example, 0.05. The HCN unit may operate above a CoV of 0.1, and CoV of 0.2 is not unusual, i.e. ranging from 0.01 to 0.2 or from 0.02 to 0.15, but above 0.1 the operating cost is higher and HCN yield is lower, for example 2% to 7% lower, translating into a lost opportunity of millions of dollars per year in continuous commercial operation.

Various control systems may be used to regulate the reactant gas flow. For example flow meters that measure the flow rate, temperature, and pressure of the reactant gas feed streams and allow a control system to provide “real time” feedback of pressure- and temperature-compensated flow rates to operators and/or control devices may be used.

As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units, computer memories (e.g., read-only memory, random access memory), and a data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

Suitable catalysts for use in the Andrussow process contain Group VIII metals. The Group VIII metals include platinum, rhodium, iridium, palladium, osmium or ruthenium and the catalyst can be such metals, a mixture of such metals or alloys of two or more of such metals. A catalyst containing from 50 wt. % (i.e., “weight percent”) up to 100 wt. % platinum, based on the total weight of the catalyst, is employed in many instances for the production of HCN. A metal, mixture or alloy containing 90 wt. % platinum and 10 wt. % rhodium, or 85 wt. % platinum and 15 wt. % rhodium, based on the total weight of the catalyst, is often the preferred catalyst. The catalyst may also include one or more layers of wire mesh, gauze, or other packed or oriented structure suitable for conducting the reaction. The catalyst must be sufficiently strong to withstand increased velocity rates that may be used in combination with a ternary gas mixture comprising at least 25 vol. % oxygen. Thus, a 85/15 platinum/rhodium alloy may be used on a flat catalyst support. A 90/10 platinum/rhodium alloy may be used with a corrugated support that has an increased surface area as compared to the flat catalyst support.

The composition of the crude hydrogen cyanide product may vary depending on the molar ratio of the feed streams and reaction conditions. For purposes of the present invention, the crude hydrogen cyanide product contains a higher concentration of water than is typically found in HCN production processes using only air. In practice, crude hydrogen cyanide product contains HCN and may also include by-product hydrogen, methane combustion byproducts (such as carbon dioxide, carbon monoxide, and water), nitrogen, residual methane, and residual ammonia as shown in Table 1. The Andrussow process, when practiced at optimal conditions, has potentially recoverable residual ammonia in the crude hydrogen cyanide product. Because the rate of HCN polymerization is known by the skilled person to increase with increasing pH, residual ammonia must be removed to avoid the polymerization of the HCN. HCN polymerization represents not only a process productivity problem, but an operational challenge as well, since polymerized HCN can cause process line blockages resulting in pressure increases and associated process control problems. Typically, ammonia is separated from the crude hydrogen cyanide product in the first step of the refining process, and HCN polymerization is inhibited by immediately reacting the HCN reactor discharge stream with an excess of acid (e.g., H₂SO₄ or H₃PO₄) such that the residual free ammonia is captured by the acid as an ammonium salt and the solution remains acidic in pH. Formic acid and oxalic acid in crude hydrogen cyanide product are captured in aqueous solution in an ammonia recovery system as formates and oxalates. In one embodiment, an electrolyzer may be used to convert formats into carbon dioxide and hydrogen as described in U.S. Pat. No. 6,872,296, the entire contents and disclosure of which is hereby incorporated by reference.

The requirement of low water, and the high purity required of HCN when it is to be used as a feed stream in a hydrocyanation process such as the hydrocyanation of 1,3-butadiene (sometimes referred to herein as “butadiene”) and pentenenitrile to produce adiponitrile, necessitate a method of producing and processing uninhibited HCN. For purposes of the present invention, “uninhibited” is used herein to mean that the HCN is substantially void of stabilizing polymerization inhibitors. Such inhibitors would require removal prior to utilizing the HCN in, for example, hydrocyanation, such as in the manufacture of adiponitrile by hydrocyanation of 1,3-butadiene and hydrocyanation of pentenenitriles, and other conversion processes known to those skilled in the art.

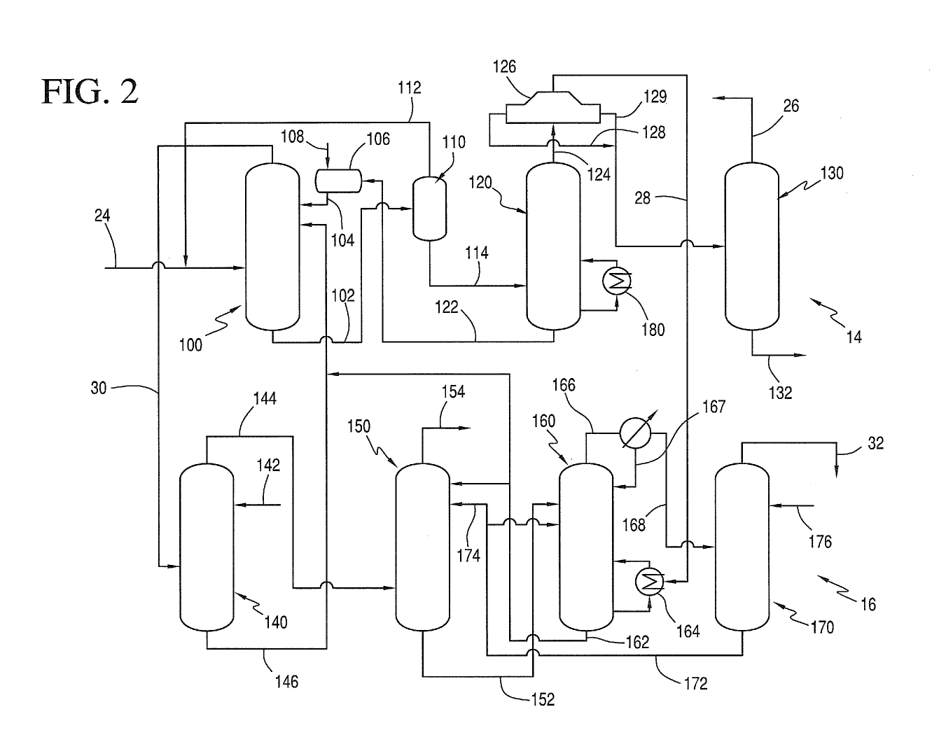

FIG. 2 represents a flow diagram of ammonia recovery system 14 and an HCN refining system 16 of the present invention. Heat is produced in ammonia recovery 14 and transferred via line 28 to HCN refining system 16. Ammonia recovery system 14 includes an ammonia absorber 100, an HCN/phosphate stripper 110, an ammonia stripper 120 and an ammonia enricher 130. In reactor assembly 12, the crude hydrogen cyanide product may be cooled to a temperature that is greater than the dew point of the composition, e.g., greater than 150° C. or greater than 200° C. Crude hydrogen cyanide product 24 is fed to a lower portion of ammonia absorber 100 and contacted with an absorbing solution 104, such as a lean phosphate feed stream, to produce an ammonia-rich phosphate stream 102 and an absorber overhead stream, also referred to as HCN refining feed stream 30. In one embodiment, ammonia-rich phosphate stream 102 has a reduced hydrogen cyanide concentration as compared to crude hydrogen cyanide product 24. Absorber overhead stream 30, comprises hydrogen cyanide and is directed to HCN refining system 16 to produce a purified HCN product 32, as discussed herein.

In one embodiment, a lean phosphate solution is stored in an ammonia absorber feed tank 106, where make up phosphoric acid stream 108 can be added to the lean phosphate solution before it is fed as lean phosphate feed stream 104 into the upper portion of ammonia absorber 100. Feed tank 106 is sufficiently sized to hold all of the ammonium phosphate solution contained in ammonia recovery system 14, thereby providing de-inventory capability and a process dynamics buffer between ammonia stripper 120 and ammonia absorber 100. Ammonia absorber feed tank 106 may be heated or cooled to maintain the temperature of the lean phosphate solution at a desired temperature for ammonia absorption in the ammonia absorber 100. Surfaces of the ammonia absorber feed tank 106 in contact with the ammonium phosphate solution may be constructed of 304 SS. The pH of lean phosphate feed stream 104 is in the range from 5 to 6.1, e.g., from 5.3 to 6.0.

Lean phosphate feed stream 104 comprises an aqueous solution of mono-ammonium hydrogen phosphate (NH₄H₂PO₄) and di-ammonium hydrogen phosphate ((NH₄)₂HPO₄) having an NH₄⁺/PO₄⁻³ ratio in the range of 1.2 to 1.7. In some embodiments, lean phosphate feed stream 104 is introduced into ammonia absorber 100 at different locations and/or at different NH₄⁺/PO₄⁻³ ratios, as more fully set forth in U.S. Pat. No. 3,718,731, the entire contents and disclosure of which is hereby incorporated by reference. In one embodiment, the temperature of lean phosphate feed stream 104 may be from 50° C. to 60° C. to achieve good absorption of ammonia from crude hydrogen cyanide product 24 into ammonia-rich phosphate stream 102.

Ammonia-rich phosphate stream 102, which has a reduced hydrogen cyanide concentration compared to the crude hydrogen cyanide product 24, is passed into the HCN/phosphate stripper 110 wherein the ammonia-rich phosphate stream 102 is heated to remove residual hydrogen cyanide present. Depending on the HCN concentration, in some embodiments, ammonia-rich phosphate stream 102 may be directly fed to ammonia stripper 120 via optional line 103.

HCN/phosphate stripper 110 produces an HCN/phosphate stripper overhead stream 112 containing hydrogen cyanide and a second ammonia-rich phosphate stream 114. Second ammonia-rich phosphate stream 114 has a reduced hydrogen cyanide concentration that is less than the hydrogen cyanide concentration of ammonia-rich phosphate stream 102. In one embodiment, a particulate filter unit (not shown) may be used to remove any HCN polymer or other particulates that may be present in the second ammonia-rich phosphate stream 114, and thereby provides a substantially polymer free stream. Second ammonia-rich phosphate stream 114 is passed into the ammonia stripper 120 wherein ammonia and the water present in the second ammonia-rich phosphate stream 114 are separated to produce an ammonia stripper overhead stream 124 and a lean phosphate stream 122.

In one embodiment, lean phosphate stream 122 exits ammonia stripper 120 at a temperature in the range from 160° C. to 165° C. and a pressure in the range from 580 to 620 kPa. Lean phosphate stream 122 is returned to ammonia absorber feed tank 106. In one embodiment, lean phosphate stream 122 may be cooled by a process-to-process heat exchanger. For example, the process-to-process heat exchanger may cool lean phosphate stream 122 by heating ammonia-rich phosphate stream 102 and/or second ammonia-rich phosphate stream 114 that is fed to ammonia stripper 120. Further cooling of lean phosphate stream 122 may be desired to effect the desired ammonia absorption in the ammonia absorber 100.

Heat to ammonia stripper 120 is provided by a heat transfer unit 180. The heat transfer unit 180 can be a natural circulation calandria which uses, for example, 1300 kPa steam on a shell side of the calandria. The calandria can be a single pass shell and tube bundle heat exchanger. Heat supplied by unit 180 generates water vapor that forces desorption of ammonia from ammonia-rich phosphate stream 102 and/or second ammonia-rich phosphate stream 114. By this action, ammonia-rich phosphate stream 102 and/or second ammonia-rich phosphate stream 114 is converted back to a lean phosphate solution in the bottom of ammonia stripper 120.

Acceptable materials of construction in ammonia stripper 120 include, but are not limited to, substantially corrosion resistant metals, zirconium, DuPlex 2205 and FERRALIUM™ 255. At lower temperatures, 316 stainless steel is acceptable.

Ammonia stripper 120 concentrates the ammonia and water into the overhead stream 124. Overhead stream 124 is condensed by feeding it directly into a waste heat boiler 126. Waste heat boiler 126 produces steam that is transferred in line 28 to HCN refining system 16. By operating ammonia stripper 120 at elevated pressure, and therefore elevated temperature, heat may be advantageously recovered from overhead stream 124 by partially condensing it in, for example, a steam-generating waste-heat boiler 126 to produce a condensed liquid stream 128 and a vapor stream 129. The steam generated may be used to provide at least a portion of the necessary heat input to one or more other columns in the HCN refining system 16, as discussed herein.

Overhead stream 124, which contains ammonia in a range from 5 to 20 vol. %, e.g., from 7 to 17 vol. %, exits the ammonia stripper 120 at a pressure in the range from 400 kPa to 600 kPa, e.g., from 550 kPa to 600 kPa and a temperature in the range from 140° C. to 175° C., e.g., from 155° C. to 170° C. Operating under lower pressures may cause entrainment in the overhead stream 124 of the phosphate.

Overhead stream 124 is partial condensed in waste heat boiler 126 and withdrawn in liquid stream 128. A vapor stream 129 may also be withdrawn from waste heat boiler 126 and separately condensed using cooled water or air. Liquid stream 128 and condensed vapor stream 129 are combined and feed to ammonia enricher 130. In ammonia enricher 130, the ammonia present in overhead stream 124 is distilled to produce an anhydrous ammonia stream that is returned to the reaction assembly via line 26, and a water stream 132 that may be purged. In one embodiment, ammonia enricher 130 recovers from 85 to 99% of the ammonia and recycles the recovered ammonia in line 26 to the reaction assembly.

In one embodiment a mixture of air/nitrogen may be fed to ammonia stripper 120 and/or ammonia enricher 130 to reduce corrosion. The mixture of air/nitrogen may have less than 9 vol. % oxygen.

Returning to HCN refining feed stream 30 withdrawn from the absorber overhead stream, this stream is fed to HCN refining system 16 to recover a purified HCN product 32. HCN refining system 16 includes an ammonia scrubber 140, an HCN absorber 150, an HCN stripper 160 and an HCN enricher 170. HCN refining feed stream 30 is introduced into a lower portion of ammonia scrubber 140 where it is scrubbed with one or more recirculated dilute acid streams 142 to remove any residual traces of ammonia from the ammonia absorber overhead stream. Dilute acid stream 142 may comprise phosphoric acid, or sulfuric acid. Acid may be added to recirculated dilute acid stream 142 to maintain a pH from 1.7 to 2.0 in scrubber tails stream 146. Ammonia scrubber 140 is designed to remove substantially all of the free ammonia present in the ammonia absorber overhead stream 30 before the scrubber overhead off-gas stream 144 enters the HCN absorber 150. The ammonia scrubber overhead off-gas stream 144 should be substantially free of ammonia because free ammonia, (i.e. un-neutralized ammonia), will raise the pH in the HCN refining system 16, thus increasing the potential for HCN polymerization. Overhead ammonia scrubber off-gas stream 144, after ammonia removal, comprises less than 1000 mpm ammonia, e.g., less than 500 mpm or less than 300 mpm. Because the rate of HCN polymerization increases with increasing pH, residual ammonia must be removed to avoid the polymerization of the HCN. HCN polymerization represents not only a process productivity problem, but an operational challenge as well, since polymerized HCN can cause process line blockages resulting in pressure increases and associated process control problems.

Ammonia scrubber tails stream 146 may be removed from a lower portion of the scrubber 140 and returned to ammonia absorber 100, as shown in FIG. 2. Preferably phosphoric acid is used in dilute acid stream 142 so that scrubber tails stream 146 may be recycled to ammonia absorber 100. In addition to heat integration, the ammonia recovery system 14 is integrated with an HCN refining system by using the same acid throughout the process. For example, using phosphoric acid (as ammonium hydrogen phosphate) in the ammonia recovery system 14 and phosphoric acid in the HCN refining system 16 allows for flexibility in recycling bleed (e.g., purge) streams, produces a more valuable ammonium phosphate byproduct compared to ammonium sulfate, eliminates the need for disposal of sulfates, and enables the use of lower cost materials of construction than can be employed with sulfuric acid. In one embodiment the two ammonia removal steps are combined into a single step. In other embodiments, however, use of two distinct ammonia removal steps reduces the risk of leaving residual ammonia in the HCN reactor discharge. Operating with two distinct ammonia removal steps, with a common phosphoric acid, enables make-up virgin phosphoric acid to be fed to the second step, where stronger acid addition is most useful, and the resulting aqueous solution of ammonium phosphate salt and excess phosphoric acid (i.e., diluted acid) may then be recycled to the first step.

An overhead off-gas stream 144 of the ammonia scrubber 140 contains HCN, water, carbon monoxide, nitrogen, hydrogen, carbon dioxide and methane. In one embodiment, the overhead off-gas stream 144 is fed to a partial condenser where it is cooled with cooling water to a temperature of 40° C. to form a cooled vapor stream and a condensed liquid stream. Dilute phosphoric acid can be sprayed into the condenser and into the cooled vapor stream to inhibit HCN polymerization. The condensed liquid stream and the cooled vapor stream from the overhead off-gas stream 144 may be fed independently to the lower portion of an HCN absorber 150. HCN is recovered by absorption into dilute acidified water to produce HCN absorber tails stream 152. An overhead off-gas stream 154 is also withdrawn from HCN absorber 150. The HCN absorber tails stream 152 includes acidified water and a minor concentration, e.g., from 2 vol. % to 8 vol. %, of HCN. To remove substantially all of the HCN, a cooled HCN stripper tails stream 162 may be fed to an upper portion of the HCN absorber 150. In addition, the HCN absorber 150 may be fed an HCN enricher tails purge stream 174, which is a “bleed” portion of an HCN enricher tails stream 172. This “bleed stream” is recycled to the HCN absorber 150 so that mid-boiling impurities such as acetonitrile, propionitrile, and acrylonitrile, which could otherwise build up in the HCN stripper-enricher columns, are removed in an HCN absorber overhead off-gas stream 154.

The HCN absorber overhead off-gas stream 154 may contain carbon monoxide, nitrogen, hydrogen, carbon dioxide, methane, argon, and trace amounts of nitriles. The main fuel components are hydrogen and carbon monoxide with some methane. If there are sufficient quantities of hydrogen, a pressure swing absorption unit may be used to recover hydrogen. Otherwise the HCN absorber overhead off-gas stream 154 may be flared, or may be used as a boiler fuel in steam producing boilers in order to recover energy. Nitriles from HCN enricher 170 via HCN enricher tails purge stream 174 may be removed in overhead off-gas stream 154.

HCN absorber tails stream 152 may be preheated to a temperature from 80° C. to 100° C. prior to being introduced into HCN stripper 160. A process-to-process heat exchanger that integrates another stream, such as the HCN stripper tails stream 162, may be used. The HCN stripper 160 has two feed streams, namely, the preheated HCN absorber tails stream 152 and a portion of the HCN enricher tails stream 172, both of which are fed to an upper portion of HCN stripper 160. The HCN enricher tails stream 172 includes a major amount of HCN, e.g., approximately 30% to 60% by weight, a minor amount of inhibitor, e.g., less than 1% by weight phosphate, and the balance being water.

Heat is introduced into the lower section of the HCN stripper 160 via a steam-heated heat transfer unit, e.g., calandria 164. For purposes of the present invention, the steam to drive calandria 164 is withdrawn from waste heat boiler 126 and may provide at least a portion of the energy, preferably 40% to 60% of the energy needed, to drive separation in HCN stripper 160. In some embodiments, additional energy may be supplied from the waste heat boiler of the reactor or from a dedicated utility. Calandria 164 can use the low pressure steam generated by waste heat boiler 126. The steam pressure in line 28 may be higher and may be let-down to lower pressure as appropriate for consumption in calandria 164. Low pressure steam may be directly fed via pipe, represented by line 28, from waste heat boiler 126 to calandria 164. In one embodiment, the pipe is less than 50 m long, e.g., less than 25 m long. This is sufficient for transporting a low pressure steam.

In addition, the production rates of ammonia stripper 120 and HCN stripper 160 are matched so that the steam produced from ammonia stripper 120 may be used by HCN stripper 160.

An HCN stripper tails stream 162 is discharged from a lower portion of the HCN stripper 160 at a temperature from 110° C. to 120° C. The HCN stripper tails stream 162 is essentially HCN-free acidified water which is cooled to a temperature from 30° C. to 65° C. and recycled to the HCN absorber 150. In some embodiments, a HCN stripper tails stream 162 may be purged as needed.

An HCN stripper off-gas stream 166, which is an intermediate stream enriched in HCN, containing a major amount of HCN and minor amounts of water and nitriles, is passed through the HCN stripper partial condenser, using cooling water, to provide a liquid reflux stream 167, largely water, and an HCN stripper vapor distillate stream 168. The temperature, and therefore purity of HCN stripper vapor distillate stream 168 is controlled consistent with the separation capacity of HCN enricher 170. The liquid reflux stream 167 is returned to the top of HCN stripper 160. HCN stripper vapor distillate stream 168 is passed to a lower portion of an HCN enricher 170. In one embodiment, the HCN stripper vapor distillate stream 168 is controlled at a pressure from 120 kPa to 140 kPa and a temperature from 45° C. to 67° C. HCN stripper vapor distillate stream 168 contains from 70 to 99 vol. % HCN, e.g. from 80 to 90 vol. % HCN.

The HCN stripper vapor distillate stream 168 is introduced into the lower portion of the HCN enricher 170. In addition to being a feed stream for the HCN enricher 170, the HCN stripper vapor distillate stream 168 provides heat to the HCN enricher 170. Thus, heat integration from ammonia recovery system 14 may be used in both HCN stripper 160 and HCN enricher 170 via line 28. Because the HCN enricher 170 is coupled to the HCN stripper 160 and requires no additional heat for distilling the HCN/water mixture, the performance of the HCN enricher 170 is highly interrelated with the HCN stripper 160 and the HCN stripper partial condenser. Acid, preferably phosphoric acid, is fed by an acid inhibitor stream 176 to one or more locations in the upper portion of the HCN enricher 170 below the uppermost location to further inhibit HCN polymerization. Uninhibited HCN is susceptible to auto-catalytic (i.e., rapid/explosive) polymerization. HCN enricher tails stream 172 may comprise HCN, water and miscellaneous organic compounds, which are returned to absorber 150 and stripper 160.

A portion of the HCN enricher tails stream 172 may be recycled as HCN enricher tails purge stream 174 to the HCN absorber 150 so that mid-boiling impurities such as acetonitrile, propionitrile, and acrylonitrile, which could otherwise build up in the HCN stripper-enricher columns are removed. Without being bound by theory the additional heat integrated from ammonia recovery system 14 may also reduce the mid-boiling impurities from building up in HCN enricher 170 by concentrating the nitrile impurities in the lower portion of HCN enricher 170. This allows a nitrile purge, either continuously or intermittently, to be used to remove mid-boiling impurities from the HCN enricher tails stream 172. In another embodiment, a side-draw stream (not shown) may be removed from the HCN enricher 170 or the HCN stripper 160 at any elevation that provides a sufficient nitriles purge rate to prevent nitrile buildup.

A purified HCN product 32 is withdrawn overhead and refluxed as needed. The purified HCN product 32 may be collected in pump tanks and gases present in the pump tanks may be vented as needed. The HCN enricher overhead stream contains substantially pure HCN and traces of water, preferably less than 100 ppm by weight, or more preferably less than 10 ppm by weight.

The distillation columns of the present invention may use packing and/or trays, such as such as bubble-cap trays, valve trays, or sieve trays. Bubble-cap trays, valve trays, and sieve trays are well known in the art. Valve trays are well known in the art and tray designs are selected to achieve good circulation, prevent stagnant areas, and prevent polymerization and corrosion. The distillation columns used herein may also incorporate an entrainment separator above the top tray to minimize carryover. Entrainment separators typically include use of techniques such as reduced velocity, centrifugal separation, demisters, screens, or packing, or combinations thereof.

It should be understand that a plurality of columns and related equipment can be employed in conjunction with ammonia recovery system 14 and HCN refining system 16 without departing from the scope of the present invention. It should also be understood that the columns, as graphically displayed in the drawings, may be constructed utilizing a variety of different designs, internals, materials of construction, flow dynamics, etc., as long as the columns function in a manner sufficiently duplicative of, or at least not substantially different than, the methods and processes described and claimed herein.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

The invention can be further understood by reference to the following examples.

### Example 1

A ternary gas mixture is formed by combining pure oxygen, an ammonia-containing gas and a methane-containing gas. The ammonia-to-oxygen molar ratio in the ternary gas mixture is 1.3:1 and the methane-to-oxygen molar ratio in the ternary gas mixture is 1.2:1 The ternary gas mixture, which comprises from 27 to 29.5 vol. % oxygen, is reacted in the presence of a platinum/rhodium catalyst to form a crude hydrogen cyanide product having a composition as shown in Table 2.

The crude hydrogen cyanide product is removed from the reactor and fed to an ammonia recovery system having an ammonia absorber and an ammonia stripper. The crude hydrogen cyanide product is first contacted with the ammonia absorber to produce an ammonia-rich phosphate stream containing ammonia and water, and an absorber overhead stream containing hydrogen cyanide. The absorber overhead stream is then separated in a hydrogen cyanide stripper to further purify the hydrogen cyanide product. The ammonia-rich phosphate stream is then sent to the ammonia stripper to vaporize ammonia and water into a stripper overhead and a lean stream. The stripper overhead stream is partially condensed in a waste heat boiler to generate steam having a pressure from 180 to 380 kPa. The steam is transferred to a hydrogen cyanide refining system where it provides from 40 to 60% of the energy used to operate the hydrogen cyanide stripper

### Comparative Example A

A ternary gas mixture is formed by combining air, an ammonia-containing gas and a methane-containing gas. The ternary gas mixture comprises less than 25 vol. % oxygen. The separation process is used as in Example 1, except that steam is not recovered. Steam is not recovered because the water content in the crude hydrogen cyanide product is too low to make steam recovery cost effective.

TABLE 2
CRUDE HYDROGEN CYANIDE PRODUCT

| | | Comparative |
|---|---|---|
| | Example 1 | Example A |
| H₂ | 34.5 | 13.3 |
| N₂ | 2.4 | 49.2 |
| CO | 4.7 | 3.8 |
| Ar | 0.1 | — |
| CH₄ | 0.8 | 0.3 |
| CO₂ | 0.4 | 0.4 |
| NH₃ | 6.6 | 2.3 |
| HCN | 16.9 | 7.6 |
| Other nitriles | <0.1 | — |
| H₂O | 33.4 | 23.1 |

1-15. (canceled)

16. A process for purifying a crude hydrogen cyanide product comprising hydrogen cyanide, ammonia, and from 25 to 50 vol. % water, the process comprising the steps of:
contacting in an ammonia absorber at least a portion of the crude hydrogen cyanide product with an absorbing solution to produce an ammonia-rich stream containing ammonia and water, and an ammonia absorber overhead stream containing hydrogen cyanide;
separating in an ammonia stripper at least a portion of the ammonia-rich stream to vaporize ammonia and water into an ammonia stripper overhead and a lean stream;
passing the ammonia stripper overhead through a waste heat boiler to generate steam having pressure of less than 400 kPa, preferably from 180 kPa to 380 kPa, and to partially condense the ammonia stripper overhead into a liquid stream;
passing at least a portion of the ammonia absorber overhead stream into an ammonia scrubber to remove residual ammonia to produce an ammonia scrubber off-gas stream;
absorbing in a hydrogen cyanide absorber at least a portion of the ammonia scrubber off-gas stream in dilute acidified water to produce a hydrogen cyanide absorber off-gas stream and a hydrogen cyanide absorber tails stream containing hydrogen cyanide;
separating in a hydrogen cyanide stripper at least a portion of the hydrogen cyanide absorber tails stream to obtain an intermediate stream, wherein the steam from the waste heat boiler is directed to a calandria of the hydrogen cyanide stripper; and
recovering in a hydrogen cyanide enricher column a purified hydrogen cyanide product from the intermediate stream.

17. The process of claim 16, wherein the ammonia stripper overhead comprises from 5 to 20 vol. % ammonia.

18. The process of claim 16, wherein the steam generated by the waste heat boiler has a pressure from 180 to 380 kPa.

19. The process of claim 16, wherein the steam provides from 40% to 60% of the energy to drive separation in hydrogen cyanide stripper.

20. The process of claim 16, wherein the intermediate stream is condensed into a liquid stream that is refluxed to the hydrogen cyanide stripper and a vapor distillate stream that is introduced into the enricher column.

21. The process of claim 20, wherein the vapor distillate stream contains the heat needed to drive separation in the enricher column.

22. The process of claim 16, further comprising passing one or more recirculated dilute acid streams into the scrubber.

23. The process of claim 16, further comprising separating a tail stream from the scrubber and feeding the tail stream to the ammonia absorber.

24. The process of claim 16, wherein the crude hydrogen cyanide product is formed from a ternary gas mixture that comprises at least 25 vol. % oxygen.

25. The process of claim 16, further comprising reducing the hydrogen cyanide concentration of the ammonia-rich stream prior to the ammonia stripper.

26. The process of claim 16, further comprising recovering ammonia from the partially condensed ammonia stripper overhead.

27. The process of claim 16, wherein the enricher column is operated to concentrate nitriles in the lower portion thereof.

28. The process of claim 16, further comprising cooling the lean stream by pre-heating the ammonia-rich stream in a process-to-process heat exchanger.

29. The process of claim 16, further comprising withdrawing a hydrogen cyanide stripper tails stream from the hydrogen cyanide stripper and cooling the hydrogen cyanide stripper tails stream by pre-heating the hydrogen cyanide absorber tails stream in a process-to-process heat exchanger.

30. The process of claim 16, wherein the off-gas stream is partially condensed into a second liquid stream and a vapor stream that are fed at different locations to the hydrogen cyanide absorber.

31. The process of claim 16, further comprising introducing an acid inhibitor into the enricher column.

32. The process of claim 16, wherein the absorbing solution is a lean phosphate solution.

33. A process for purifying a crude hydrogen cyanide product comprising hydrogen cyanide, ammonia, and from 25 to 50 vol. % water, the process comprising the steps of:
recovering ammonia from the crude hydrogen cyanide product using at least one lean solution and generating steam having pressure of less than 400 kPa by cooling an ammonia-water solution;
recovering hydrogen cyanide using acidified water from at least a portion of the crude hydrogen cyanide product; and
directing the generated steam to drive the separation of hydrogen cyanide and acidified water.

34. The process of claim 33, wherein the steam has a pressure from 180 to 380 kPa.

35. A heat integration apparatus, comprising:
an ammonia absorber for contacting a crude hydrogen cyanide product comprising hydrogen cyanide, ammonia, and water with an absorbing solution to produce an ammonia-rich stream containing ammonia and water, and an absorber overhead stream containing hydrogen cyanide;
an ammonia stripper for separating at least a portion of the ammonia-rich stream to vaporize ammonia and water into an ammonia stripper overhead and a lean stream;
a waste heat boiler for generating steam by passing the ammonia stripper overhead therethrough, wherein the steam has a pressure of less than 400 kPa, and for partially condensing the ammonia stripper overhead into a liquid stream;
an ammonia scrubber for removing residual ammonia from at least a portion of the ammonia absorber overhead stream to produce an ammonia scrubber off-gas stream;
a hydrogen cyanide absorber for contacting a portion of the off-gas stream with dilute acidified water to produce a hydrogen cyanide absorber off-gas stream and a hydrogen cyanide absorber tails stream containing hydrogen cyanide;
a hydrogen cyanide stripper for separating at least a portion of the hydrogen cyanide absorber tails stream to obtain a hydrogen cyanide stream, wherein the hydrogen cyanide stripper has a calandria; and
a pipe for directing the steam from the waste heat boiler to the calandria.
